(19) United States
(12) Patent Application Publication
(10) Pub. No.: US 2023/0171500 A1
(43) Pub. Date: Jun. 1, 2023

(54) IMAGING SYSTEM, IMAGING METHOD, AND COMPUTER PROGRAM

(71) Applicant: NEC Corporation, Minato-ku, Tokyo (JP)

(72) Inventors: Yuka OGINO, Minato-ku, Tokyo (JP); Keiichi Chono, Tokyo (JP)

(73) Assignee: NEC Corporation, Minato-ku, Tokyo (JP)

(21) Appl. No.: 17/922,634

(22) PCT Filed: May 14, 2020
(86) PCT No.: PCT/JP2020/019310

§ 371 Date: Nov. 1, 2022

(51) Int. Cl. H04N 23/695; H04N 7/18; G06T 7/20

(52) U.S. Cl. CPC H04N 23/695; H04N 7/181; G06T 7/20; G06V 40/18

(57) ABSTRACT

An imaging system includes: an acquisition unit that obtains a plurality of images of a subject captured at different timing; an estimation unit that estimates a motion of the subject on the basis of the plurality of images; and a change unit that changes a set value of an imaging unit for imaging a particular part of the subject, in accordance with the movement of the subject. According to such an imaging system, it is possible to properly capture the images of the subject.

### TECHNICAL FIELD

This disclosure relates to an imaging system, an imaging method, and a computer program that image a subject.

### BACKGROUND ART

A known system of this type captures an image of the periphery of the eyes of a subject (e.g., an iris image, etc.). For example, Patent Literature 1 discloses a technique/technology of changing an imaging direction of a narrow-angle camera on the basis of an image captured by a wide-angle camera. Patent Literature 2 discloses a technique/technology of detecting the position of an iris by an imaging unit with a wide-angle lens mounted thereon and of capturing an image of the iris by an imaging unit with a narrow-angle lens mounted thereon. Patent Literature 3 discloses a technique/technology of changing an imaging direction of a narrow camera on the basis of the position of a pupil in an image captured by a wide camera.

### CITATION LIST

### Patent Literature

Patent Literature 1: JP2015-192343A

Patent Literature 2: JP2008-299045A

Patent Literature 3: JP2003-030633A

### SUMMARY

### Technical Problem

In view of the above-described cited documents, it is an example object of this disclosure to provide an imaging system, an imaging method, and a computer program that are configured to properly capture an image of the subject.

### Solution to Problem

An imaging system according to an example aspect of this disclosure includes: an acquisition unit that obtains a plurality of images of a subject captured at different timing; an estimation unit that estimates a motion of the subject on the basis of the plurality of images; and a change unit that changes a set value of an imaging unit for imaging a particular part of the subject, in accordance with the movement of the subject.

An imaging method according to an example aspect of this disclosure includes: obtaining a plurality of images of a subject captured at different timing; estimating a motion of the subject on the basis of the plurality of images; and changing a set value of an imaging unit for imaging a particular part of the subject, in accordance with the movement of the subject.

A computer program according to an example aspect of this disclosure operates a computer: to obtain a plurality of images of a subject captured at different timing; to estimate a motion of the subject on the basis of the plurality of images; and to change a set value of an imaging unit for imaging a particular part of the subject, in accordance with the movement of the subject.

### BRIEF DESCRIPTION OF DRAWINGS

FIG. 1 is a block diagram illustrating a hardware configuration of an imaging system according to a first example embodiment.

FIG. 2 is a block diagram illustrating a functional configuration of the imaging system according to the first example embodiment.

FIG. 3 is a flowchart illustrating a flow of operation of the imaging system according to the first example embodiment.

FIG. 4 is a block diagram illustrating a functional configuration of an imaging system according to a first modified example.

FIG. 5 is a block diagram illustrating a functional configuration of an imaging system according to a second modified example.

FIG. 6 is a block diagram illustrating a functional configuration of an imaging system according to a third modified example.

FIG. 7 is a conceptual diagram illustrating a vertical movement of a head of a subject due to a gait.

FIG. 8 is a conceptual diagram illustrating an example of a method of moving a ROI of an iris camera in accordance with a movement of the subject

FIG. 9 is a flowchart illustrating a flow of operation of an imaging system according to a third example embodiment.

FIG. 10 is a conceptual diagram illustrating an example of a method of calculating a moving direction of the subject by using an optical flow.

FIG. 11 is a conceptual diagram illustrating an example of a method of calculating the moving direction of the subject from a change in an eye position.

FIG. 12 is a flowchart illustrating a flow of operation of an imaging system according to a fourth example embodiment

FIG. 13 is a conceptual diagram illustrating an example of a method of periodically oscillating the ROI by estimating a gait period of the subject

FIG. 14 is a flowchart illustrating a flow of operation of an imaging system according to a fifth example embodiment.

### DESCRIPTION OF EXAMPLE EMBODIMENTS

Hereinafter, an imaging system, an imaging method, and a computer program according to example embodiments will be described with reference to the drawings.

### First Example Embodiment

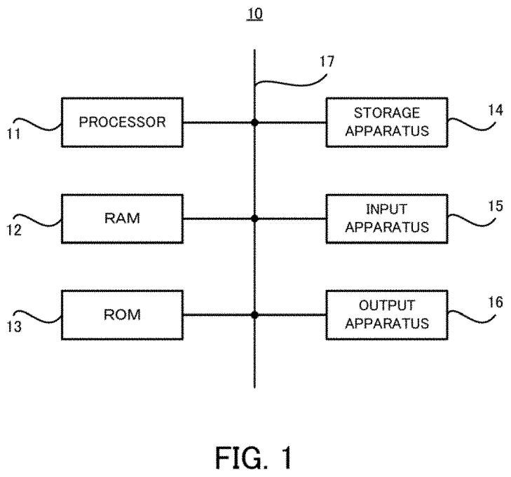

An imaging system according to a first example embodiment will be described with reference to FIG. 1 to FIG. 3.

### (Hardware Configuration)

First, with reference to FIG. 1, a hardware configuration of an imaging system 10 according to the first example embodiment will be described. FIG. 1 is a block diagram illustrating the hardware configuration of the imaging system according to the first example embodiment.

As illustrated in FIG. 1, the imaging system 10 according to the first example embodiment includes a processor 11, a RAM (Random Access Memory) 12, a ROM (Read Only Memory) 13, and a storage apparatus 14. The imaging system 10 may also include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored in at least one of the RAM 12, the ROM 13 and the storage apparatus 14. Alternatively, the processor 11 may read a computer program stored by a computer readable recording medium by using a not-illustrated recording medium reading apparatus. The processor 11 may obtain (i.e., read) a computer program from a not-illustrated apparatus that is located outside the imaging system 10 through a network interface. The processor 11 controls the RAM 12, the storage apparatus 14, the input apparatus 15, and the output apparatus 16 by executing the read computer program. Especially in the first example embodiment, when the processor 11 executes the read computer program, a functional block for imaging a subject is realized or implemented in the processor 11. As the processor 11, one of the CPU (Central Processing Unit), GPU (Graphics Processing Unit), FPGA (Field-Programmable Gate Array), DSP (Demand-Side Platform), and ASIC (Application Specific Integrated Circuit) may be used. Furthermore, a plurality of those may be used in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the imaging system 10. The storage apparatus 14 may operate as a temporary storage apparatus of the processor 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the imaging system 10. The input apparatus 15 may include, for example, at least one of a keyboard, a mouse, and a touch panel.

The output apparatus 16 is an apparatus that outputs information about the imaging system 10 to the outside. For example, the output apparatus 16 may be a display apparatus (e.g., a display) that is configured to display the information about the imaging system 10.

### (Functional Configuration)

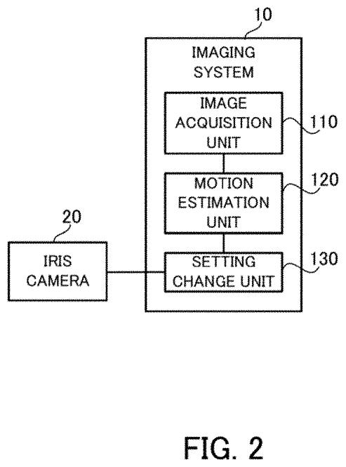

Next, with reference to FIG. 2, a functional configuration of the imaging system 10 according to the first example embodiment will be described. FIG. 2 is a block diagram illustrating the functional configuration of the imaging system according to the first example embodiment.

As illustrated in FIG. 2, the imaging system 10 according to the first example embodiment is connected to an iris camera 20 that is configured to image an iris of the subject. The imaging system 10 may be connected to a camera other than the iris camera 20 (i.e., a camera that images a part other than the iris of the subject).

The imaging system 10 includes, as processing blocks for realizing the function, an image acquisition unit 110, a motion estimation unit 120, and a setting change unit 130. The image acquisition unit 110, the motion estimation unit 120, and the setting change unit 130 may be realized or implemented, for example, in the processor 11 described above (see FIG. 1).

The image acquisition unit 110 is configured to obtain an image of the subject whose iris is to be imaged by the iris camera 20. The image acquisition unit 110 not necessarily obtains the image from the iris camera 20. The image acquisition unit 110 obtains a plurality of images of the subject captured at different timing. The plurality of images obtained by the image acquisition unit 110 are configured to be outputted to the motion estimation unit 120.

The motion estimation unit 120 is configured to estimate a motion (in other words, a moving direction) of the subject by using the plurality of images obtained by the image acquisition unit 110. A detailed description of a specific method of estimating the motion of the subject from the plurality of images will be omitted because the existing techniques/technologies can be properly adopted to the method. Information about the motion of the subject estimated by the motion estimation unit 120 is configured to be outputted to the setting change unit 130.

The setting change unit 130 is configured to change a set value of the iris camera 20 in accordance with the motion of the subject estimated by the motion estimation unit 120. The “set value” here is an adjustable parameter that influences the image captured by the iris camera 20, and a typical example thereof is a value related to a ROI (Region Of Interest) of the iris camera. The set value may be calculated from the motion of the subject, or may be determined from a preset map or the like. An initial value of the ROI (i.e., a value before the change by the setting change unit 130) may be set on the basis of the motion of the subject, or a height of the eyes of the subject obtained by a camera other than the iris camera (e.g., an overall overhead camera 30 described later) or a sensor or the like.

### (Flow of Operation)

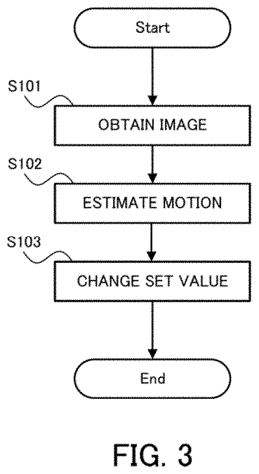

Next, with reference to FIG. 3, a flow of operation of the imaging system 10 according to the first example embodiment will be described. FIG. 3 is a flowchart illustrating the flow of the operation of the imaging system according to the first example embodiment.

As illustrated in FIG. 3, in operation of the imaging system 10 according to the first example embodiment, first, the image acquisition unit 110 obtains a plurality of images of the subject (step S101). Then, the motion estimation unit 120 estimates the motion of the subject from the plurality of images (step S102).

Then, the setting change unit 130 changes the set value of the iris camera 20 in accordance with the motion of the subject (step S103). As a result, the imaging of the subject by the iris camera 20 is performed in a state in which the set value is changed.

### Technical Effect

Next, a technical effect obtained by the imaging system 10 according to the first example embodiment will be described.

As for a walking subject, the position of each part of the body changes in accordance with a gait. Therefore, even if the position of a part that is desirably to be imaged is specified in advance, it is not easy to properly image the part that is desirably to be imaged at actual imaging timing.

As described in FIG. 1 to FIG. 3, in the imaging system 10 according to the first example embodiment, the motion of the subject is estimated from a plurality of images, and the set value of the iris camera 20 is changed in accordance with the estimated motion. It is therefore possible to perform the imaging by the iris camera 20 in an appropriate state in which the motion of the subject is considered.

### MODIFIED EXAMPLES

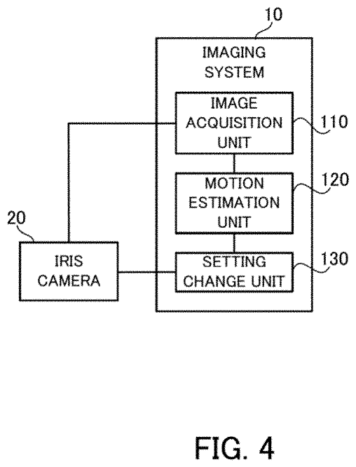

Hereinafter, modified examples of the first example embodiment will be described with reference to FIG. 4 to FIG. 6. In FIG. 4 to FIG. 6, the same components as those illustrated in FIG. 2 carry the same reference numerals. The following modified examples may be combined with each other. Furthermore, the following modified examples are also applicable to the second example embodiment described later.

### First Modified Example

First, a first modified example will be described with reference to FIG. 4. FIG. 4 is a block diagram illustrating a functional configuration of an imaging system according to the first modified example.

As illustrated in FIG. 4, the image acquisition unit 110 may be configured to obtain a plurality of images from the iris camera 20. In this case, in the iris camera 20, first, a plurality of images for estimating the motion of the subject are captured, then, the set value is changed in accordance with the movement of the subject, and then, an iris image of the subject is captured. In the first modified example, a camera other than the iris camera 20 is not required, and thus, it is possible to prevent the complication of the system and an increase in cost.

### Second Modified Example

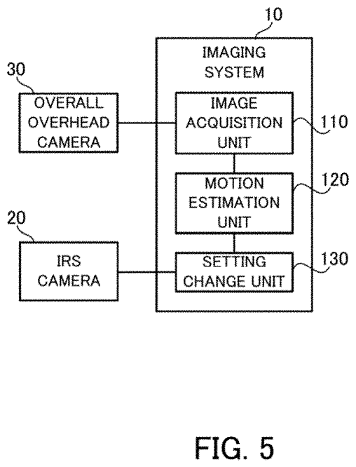

Next, a second modified example will be described with reference to FIG. 5. FIG. 5 is a block diagram illustrating a functional configuration of an imaging system according to the second modified example.

As illustrated in FIG. 5, the image acquisition unit 110 may be configured to obtain a plurality of images from an overall overhead camera 30. The overall overhead camera 30 is configured as a camera with a wider imaging range (i.e., angle of view) than that of the iris camera 20. In the second modified example, for example, it is possible to estimate the motion of the subject from an image that shows a whole body of the subject. Therefore, in comparison with a case of estimating the motion of the subject only by using the iris camera 20 (i.e., the first modified example), it is possible to estimate the motion of the subject more flexibly.

### Third Modified Example

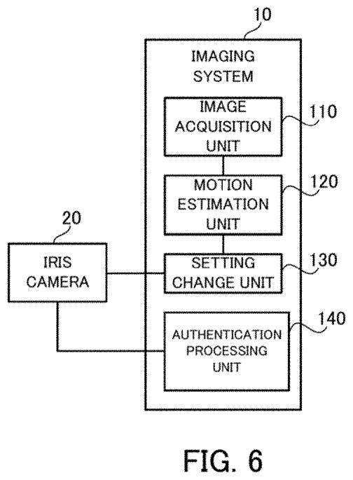

Next, a third modified example will be described with reference to FIG. 6. FIG. 6 is a block diagram illustrating a functional configuration of an imaging system according to the third modified example.

As illustrated in FIG. 6, the imaging system 10 may further include an authentication processing unit 140 in addition to the configuration illustrated in FIG. 1. The authentication processing unit 140 is configured to execute iris authentication (i.e., biometric authentication) by using the image captured by the iris camera 20. Here, in particular, the iris image captured by the iris camera 20 is captured in the state in which the motion of the subject is considered, as described above. Therefore, the accuracy of the iris authentication can be improved. The authentication processing unit 140 may be realized or implemented, for example, in the processor 11 described above (see FIG. 1). Alternatively, the authentication processing unit 140 may be provided outside the imaging system 10 (e.g., an external server, a cloud, etc.).

### Second Example Embodiment

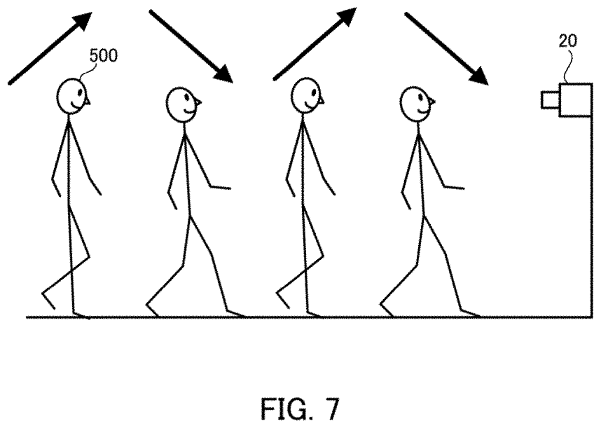

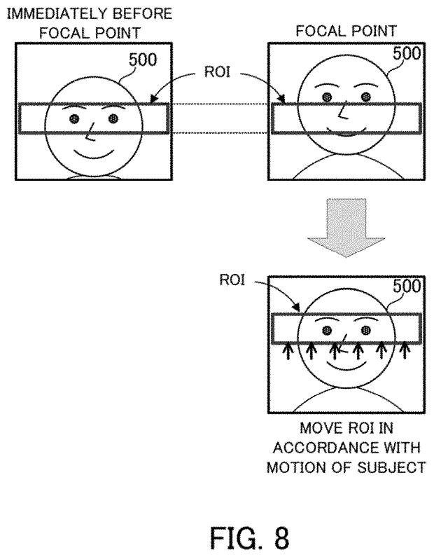

The imaging system 10 according to a second example embodiment will be described with reference to FIG. 7 and FIG. 8. The second example embodiment describes a specific example of the change in the set value in the first example embodiment described above, and may be the same as the first example embodiment (see FIG. 1 to FIG. 3) in configuration and the flow of operation thereof. Therefore, in the following, a description of the parts that overlap with the first example embodiment will be omitted as appropriate.

### (Vertical Movement of Head by Gait)

First, with reference to FIG. 7, a vertical movement of a head of the subject by a gait will be described. FIG. 7 is a conceptual diagram illustrating the vertical movement of the head of the subject due to the gait.

As illustrated in FIG. 7, the head of a walking subject 500 moves vertically due to the gait. Therefore, when the iris of the subject 500 is to be imaged by the iris camera 20, an iris position (i.e., an eye position) continues to move due to the gait, and it is not easy to capture an appropriate image. In particular, since the iris camera 20 is required to capture a high-definition image and to perform high-speed communication, its imaging range is often set relatively narrow. Therefore, it is not easy to precisely include the iris of the subject 500 in the imaging range (i.e., the ROI) of the iris camera 20.

In contrast, in the imaging system 10 according to the second example embodiment, the iris image of the subject 500 is captured by moving the ROI in accordance with the motion of the subject 500. That is, in the second example embodiment, the ROI of the iris camera 20 is changed as the set value of the iris camera 20. More specifically, the eyes (i.e., a particular part) of the subject 500 is controlled to be included in the the ROI of the iris camera at a focal point of the iris camera 20.

Next, with reference to FIG. 8, a method of changing the ROI of the iris camera will be described. FIG. 8 is a conceptual diagram illustrating an example of a method of moving the ROI of the iris camera in accordance with the motion of the subject.

As illustrated in FIG. 8, when the ROI is fixed, even if the eye position of the subject is included in the ROI immediately before the focal point of the iris camera 20, the eye position of the subject may be out of the ROI at the focal point, which is immediately after that. Therefore, even if the eye position can be accurately estimated immediately before the focal point, it is hard to include the eye position in the ROI at the focal point.

In the imaging system 10 according to the second example embodiment, however, the ROI of the iris camera 20 is moved in accordance with the motion of the subject 500. For example, in the example illustrated in FIG. 8, it can be seen that the subject 500 is moving to an upper side of the imaging range. In this case, the setting change unit 130 changes the ROI of the iris camera 20 to move upward. Consequently, the eyes of the subject 500 is included in the ROI of the iris camera at the focal point of the iris camera 20. The ROI may be moved by changing the read pixels of the iris camera 20, or the iris camera 20 itself may be moved. When the iris camera 20 itself is moved, the iris camera 20 may be pan-tilted in a main body angle, or a main body of the iris camera 20 may be moved vertically and horizontally, or an operation mirror that is aligned to an optical axis of the iris camera 20 may be pan-tilted, or these may be combined. Alternatively, a plurality of iris cameras with differing imaging ranges may be prepared to appropriately select the iris camera 20 to use in the imaging.

### Technical Effect

Next, a technical effect obtained by the imaging system 10 according to the second example embodiment will be described.

As described in FIG. 7 and FIG. 8, in the imaging system 10 according to the second example embodiment, the ROI is moved in accordance with the motion of the subject 500. Therefore, even when the subject 500 is moving, it is possible to properly image the iris. The above-described example exemplifies a case where the subject 500 moves vertically, but even when the subject moves in a lateral direction or in a diagonal direction, it is possible to properly realize the imaging by moving the ROI in that direction.

### Third Example Embodiment

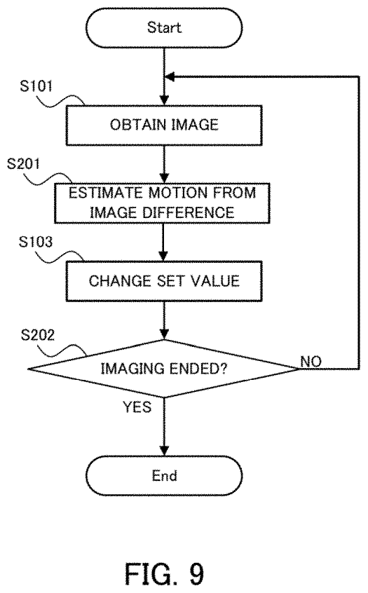

The imaging system 10 according to a third example embodiment will be described with reference to FIG. 9 to FIG. 11. The third example embodiment is partially different from the first and second example embodiments described above only in operation, and may be the same as the first example embodiment (see FIG. 1 and FIG. 2) or the modified examples thereof (see FIG. 4 to FIG. 6) in configuration. Therefore, in the following, a description of the parts that overlap with the already-described parts will be omitted as appropriate.

### (Flow of Operation)

First, with reference to FIG. 9, a flow of operation of the imaging system 10 according to the third example embodiment will be described. FIG. 9 is a flowchart illustrating the flow of the operation of the imaging system according to the third example embodiment. In FIG. 9, the same steps as those illustrated in FIG. 3 carry the same reference numerals.

As illustrated in FIG. 9, in operation of the imaging system 10 according to the third example embodiment, first, the image acquisition unit 110 obtains a plurality of images of the subject 500 (the step S101). Especially in the third example embodiment, the motion estimation unit 120 estimates the motion of the subject 500 by using a difference between the plurality of images (step S201).

Then, the setting change unit 130 changes the set value of the iris camera 20 in accordance with the motion of the subject 500 (the step S103). Then, when it is determined that the imaging is ended (step S202: YES), a series of operations is ended. Whether or not the imaging is ended may be determined by whether or not a number of captured images set in advance are obtained.

On the other hand, when it is not determined that the imaging is ended (the step S202: NO), the process is repeatedly performed from the step S101. Therefore, in the third example embodiment, the set value of the iris camera 20 is sequentially changed until the imaging of the iris image by the iris camera 20 is ended.

### (Specific Estimation Method)

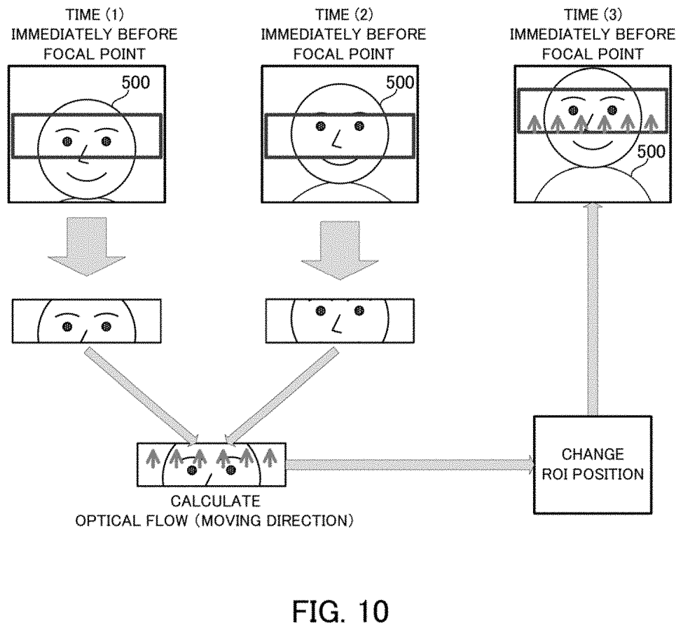

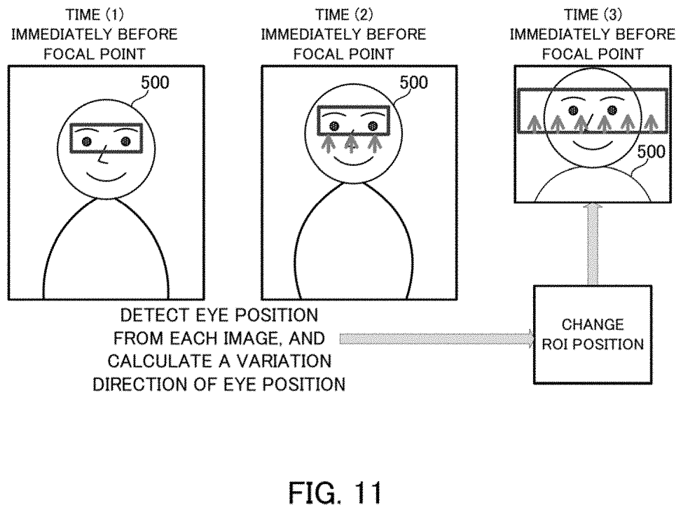

Next, with reference to FIG. 10 and FIG. 11, a specific example of a method of estimating the motion of the subject 500 by using the image difference will be described. FIG. 10 is a conceptual diagram illustrating an example of a method of calculating the moving direction of the subject by using an optical flow. FIG. 11 is a conceptual diagram illustrating an example of a method of calculating the moving direction of the subject from a change in the eye position.

As illustrated in FIG. 10, in the imaging system 10 according to the third example embodiment, the motion of the subject 500 may be estimated by using an optical flow. Specifically, the motion estimation unit 120 calculates the optical flow from an image captured by the iris camera 20 at a time (1) immediately before the focal point and from an image captured by the iris camera 20 at a time (2) immediately before the focal point, which is immediately after the point (1). The setting change unit 130 then moves the ROI of the iris camera 20 on the basis of the calculated optical flow. Consequently, at a time (3) immediately before the focal point, which is immediate after the time (2), the iris image is captured in a state in which the ROI is moved upward (i.e., in a direction of the optical flow).

As illustrated in FIG. 11, in the imaging system 10 according to the third example embodiment, the motion of the subject 500 may be estimated by detecting the eye position of the subject 500. Specifically, the motion estimation unit 120 detects the eye position of the subject 500 from each of an image captured by the overall overhead camera 30 at the time (1) immediately before the focal point and an image captured by the overall overhead camera 30 at the time (2) immediately before the focal point, which is immediately after the point (1). Incidentally, the existing techniques/technologies can be properly adapted to the detection of the eye position. The motion estimation unit 120 calculates a change direction of the eye position of the subject 500 from a difference in the eye positions between the two images. Then, the setting change unit 130 moves the ROI of the iris camera 20 on the basis of the calculated change direction of the eye position. Consequently, at the time (3) immediately before the focal point, which is immediate after the time (2), the iris image is captured in the state in which the ROI is moved upward (i.e., in the change direction of the eye position).

### Technical Effect

Next, a technical effect obtained by the imaging system 10 according to the third example embodiment will be described.

As described in FIG. 9 to FIG. 11, in the imaging system 10 according to the third example embodiment, the motion of the subject 500 is estimated from the difference between a plurality of images, and the ROI (i.e., the set value) of the iris camera 20 is changed. In this way, the set value of the iris camera 20 is sequentially changed in accordance with the motion of the subject 500, and it is thus possible to capture the images of the subject 500 more appropriately.

### Fourth Example Embodiment

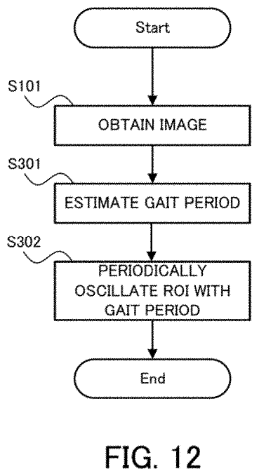

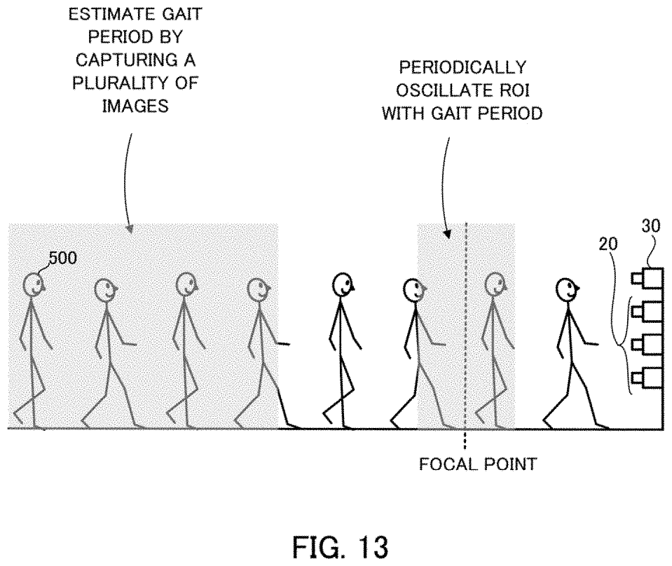

The imaging system 10 according to a fourth example embodiment will be described with reference to FIG. 12 and FIG. 13. The fourth example embodiment is partially different from the first to third example embodiments described above only in operation, and may be the same as the first example embodiment (see FIG. 1 and FIG. 2) or the modified examples thereof (see FIG. 4 to FIG. 6) in configuration. Therefore, in the following, a description of the parts that overlap with the already-described parts will be omitted as appropriate.

### (Flow of Operation)

First, with reference to FIG. 12, a flow of operation of the imaging system 10 according to the fourth example embodiment will be described. FIG. 12 is a flowchart illustrating the flow of the operation of the imaging system according to the fourth example embodiment. In FIG. 12, the same steps as those illustrated in FIG. 3 carry the same reference numerals.

As illustrated in FIG. 12, in operation of the imaging system 10 according to the fourth example embodiment, first, the image acquisition unit 110 obtains a plurality of images of the subject 500 (the step S101). Especially in the fourth example embodiment, the motion estimation unit 120 estimates a gait period of the subject 500 from the plurality of images (step S301). The existing techniques/technologies can be adopted, as appropriate, to a method of estimating the gait period using the plural of images.

Then, the setting change unit 130 periodically oscillates the ROI of the iris camera 20 in accordance with the gait period of the subject 500 (step S302). Therefore, the ROI of the iris camera 20 continues to change in accordance with the gait period of the subject 500. The gait period of the subject 500 is typically related to the vertical movement (see FIG. 7), but it may be related, for example, to movement in a lateral direction or in a diagonal direction.

### Specific Operation Example

Next, with reference to FIG. 13, a more specific operation example of the imaging system 10 according to the fourth example embodiment will be described. FIG. 13 is a conceptual diagram illustrating an example of a method of periodically oscillating the ROI by estimating the gait period of the subject

As illustrated in FIG. 13, in the imaging system 10 according to the fourth example embodiment, a plurality of images are captured and the gait period of the subject 500 is estimated in an area before the focal point of the iris camera. The area for estimating the gait period may be set in advance, and it is possible to detect that the subject 500 enters the area for estimating the gait period, for example, by placing various sensors or the like.

Then, when the subject 500 arrives around the focal point of the iris camera 20 (in other words, the area in which the iris camera 20 captures the iris image), the ROI of the iris camera 20 is periodically oscillated in accordance with the estimated gait period. The ROI of the iris camera 20 typically continues to be oscillated until a process of imaging of the iris image 20 (e.g., a predetermined number of images) is completed.

### Technical Effect

Next, a technical effect obtained by the imaging system 10 according to the fourth example embodiment will be described.

As described in FIG. 12 and FIG. 13, in the imaging system 10 according to the fourth example embodiment, the gait period of the subject 500 is estimated from the plurality of images, and the ROI (i.e., the set value) of the iris camera 20 is changed in accordance with the gait period. In this way, the ROI of the iris camera 20 is moved to follow the motion of the subject 500, and it is thus possible to capture the iris image of the subject 500 more appropriately. Furthermore, the imaging system 10 according to the fourth example embodiment has a less processing load when estimating the motion of the subject, than a processing load in the third example embodiment described above (i.e., a processing load when estimating the motion of the subject 500 from the image difference). Therefore, it is possible to shorten a processing time, and it is possible to maintain a high-speed frame rate when the iris image is captured near the focal point. It is thus possible to capture the iris image in better focus.

### Fifth Example Embodiment

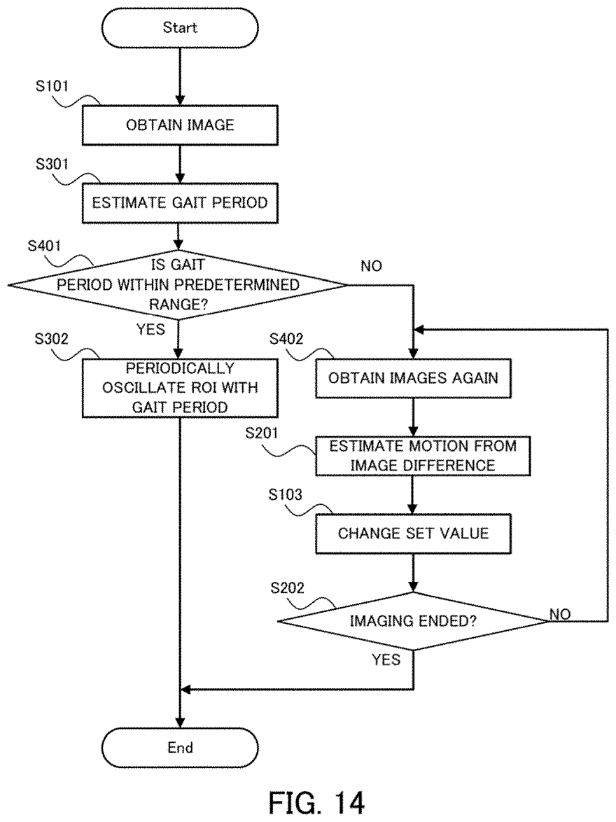

The imaging system 10 according to a fifth example embodiment will be described with reference to FIG. 14. The fifth example embodiment is a combination of the third and fourth example embodiments described above, and may be the same as the first example embodiment (see FIG. 1 and FIG. 2) or the modified examples thereof (see FIG. 4 to FIG. 6) in configuration. Therefore, in the following, a description of the parts that overlap with the already-described parts will be omitted as appropriate.

### (Flow of Operation)

First, with reference to FIG. 14, a flow of operation of the imaging system 10 according to the fifth example embodiment will be described. FIG. 14 is a flowchart illustrating the flow of the operation of the imaging system according to the fifth example embodiment. In FIG. 14, the same steps as those illustrated in FIG. 9 and FIG. 12 carry the same reference numerals.

As illustrated in FIG. 14, in operation of the imaging system 10 according to the fifth example embodiment, first, the image acquisition unit 110 obtains a plurality of images of the subject 500 (the step S101). Then, the motion estimation unit 120 estimates the gait period of the subject 500 from the plurality of images (the step S301).

Here, in particular, the imaging system 10 according to the fifth example embodiment determines whether the estimated gait period is within a predetermined range (step S401). The “predetermined range” here is a threshold value for determining whether the periodic oscillation of the ROI using the gait period (i.e., the operation in the fourth example embodiment described above) can be realized. For example, a generally assumed gait period may be set within the predetermined range, whereas an irregular gait of an injury person or a disabled person in walking or the like may be set out of the predetermined range.

When it is determined that the gait period is within the predetermined range (the step S401: YES), the setting change unit 130 periodically oscillates the ROI of the iris camera 20 in accordance with the gait period of the subject 500 (the step S302). That is, the same operation as in the fourth example embodiment is realized (see FIG. 12 and FIG. 13, etc.).

On the other hand, when it is determined that the gait period is not within the predetermined range (the step S401: NO), the image acquisition unit 110 obtains images of the subject again (step S402), and the motion estimation unit 120 estimates the motion of the subject 500 by using a difference between the plurality of images (the step S201). Then, the setting change unit 130 changes the set value of the iris camera 20 in accordance with the motion of the subject 500 (the step S103). Then, when it is determined that the imaging is ended (the step S202: YES), a series of operations is ended. On the other hand, when it is not determined that the imaging is ended (the step S202: NO), the process is repeatedly performed from the step S401. That is, the same operation as in the third example embodiment is realized (see FIG. 9 to FIG. 11, etc.).

### Technical Effect

Next, a technical effect obtained by the imaging system 10 according to the fifth example embodiment will be described.

As described in FIG. 14, in the imaging system 10 according to the fifth example embodiment, when the gait period is within the predetermined range, the ROI is periodically oscillated in accordance with the gait period. Therefore, as in the fourth example embodiment, the motion of the subject 500 can be estimated with a relatively small processing load. On the other hand, when the gait period is not within the predetermined range, the ROI is changed by using the image difference. Therefore, even when it is hard to estimate the motion of the subject by using the gait period, it is possible to reliably estimate the motion of the subject and to properly change the ROI.

### SUPPLEMENTARY NOTES

The example embodiments described above may be further described as, but not limited to, the following Supplementary Notes.

### Supplementary Note 1

An imaging system described in Supplementary Note 1 is an imaging system including: an acquisition unit that obtains a plurality of images of a subject captured at different timing; an estimation unit that estimates a motion of the subject on the basis of the plurality of images; and a change unit that changes a set value of an imaging unit for imaging a particular part of the subject, in accordance with the movement of the subject.

### Supplementary Note 2

An imaging system described in Supplementary Note 2 is the imaging system described in Supplementary Note 1, wherein the change unit changes the set value such that the particular part is included in an imaging range of the imaging unit at a focal point of the imaging unit.

### Supplementary Note 3

An imaging system described in Supplementary Note 3 is the imaging system described in Supplementary Note 1 or 2, wherein the estimation unit estimates the motion of the subject from a difference between the plurality of images.

### Supplementary Note 4

An imaging system described in Supplementary Note 4 is the imaging system described in Supplementary Note 1 or 2, wherein the estimation unit estimates the motion of the subject by estimating a gait period of the subject from the plurality of images.

### Supplementary Note 5

An imaging system described in Supplementary Note 5 is the imaging system described in Supplementary Note 4, wherein the estimation unit estimates the motion of the subject from the difference between the plurality of images, when the gait period is not within a predetermined range.

### Supplementary Note 6

An imaging system described in Supplementary Note 6 is the imaging system described in any one of Supplementary Notes 1 to 5, wherein the acquisition unit obtains the plurality of images from the imaging unit.

### Supplementary Note 7

An imaging system described in Supplementary Note 7 is the imaging system described in any one of Supplementary Notes 1 to 5, wherein the acquisition unit obtains the plurality of images from a second imaging unit that is different from the imaging unit.

### Supplementary Note 8

An imaging system described in Supplementary Note 8 is the imaging system described in any one of Supplementary Notes 1 to 7, further comprising an authentication unit that performs a process of authenticating the subject by using an image of the particular part captured by the imaging unit.

### Supplementary Note 9

An imaging method described in Supplementary Note 9 is an imaging method including: obtaining a plurality of images of a subject captured at different timing; estimating a motion of the subject on the basis of the plurality of images; and changing a set value of an imaging unit for imaging a particular part of the subject, in accordance with the movement of the subject.

### Supplementary Note 10

A computer program described in Supplementary Note 10 is a computer program that operates a computer: to obtain a plurality of images of a subject captured at different timing; to estimate a motion of the subject on the basis of the plurality of images; and to change a set value of an imaging unit for imaging a particular part of the subject, in accordance with the movement of the subject.

This disclosure is not limited to the examples described above and is allowed to be changed, if desired, without departing from the essence or spirit of the invention which can be read from the claims and the entire specification. An imaging system, an imaging method, and a computer program with such modifications are also intended to be within the technical scope of this disclosure.

### DESCRIPTION OF REFERENCE CODES

10 Imaging system
20 Iris camera
30 Overall Overhead View Camera
110 Image acquisition unit
120 Motion estimation unit
130 Setting change unit
140 Authentication processing unit
500 Subject

What is claimed is:

1. An imaging system comprising:
at least one memory that is configured to store instructions; and
at least one processor that is configured to execute instructions
to obtain a plurality of images of a subject captured at different timing;
to estimate a motion of the subject on the basis of the plurality of images; and
to change a set value of an imaging unit for imaging a particular part of the subject, in accordance with the movement of the subject.

2. The imaging system according to claim 1, wherein the processor changes the set value such that the particular part is included in an imaging range of the imaging unit at a focal point of the imaging unit.

3. The imaging system according to claim 1, wherein the processor estimates the motion of the subject from a difference between the plurality of images.

4. The imaging system according to claim 1, wherein the processor estimates the motion of the subject by estimating a gait period of the subject from the plurality of images.

5. The imaging system according to claim 4, wherein the processor estimates the motion of the subject from the difference between the plurality of images, when the gait period is not within a predetermined range.

6. The imaging system according to claim 1, wherein the processor obtains the plurality of images from the imaging unit.

7. The imaging system according to claim 1, wherein the processor obtains the plurality of images from a second imaging unit that is different from the imaging unit.

8. The imaging system according to claim 1, further comprising a processor that is configured to execute instructions to perform a process of authenticating the subject by using an image of the particular part captured by the imaging unit.

9. An imaging method comprising:
obtaining a plurality of images of a subject captured at different timing;
estimating a motion of the subject on the basis of the plurality of images; and
changing a set value of an imaging unit for imaging a particular part of the subject, in accordance with the movement of the subject.

10. A non-transitory recording medium on which a computer program that allows a computer to execute an imaging method is recorded, the imaging method comprising:
obtaining a plurality of images of a subject captured at different timing;
estimating a motion of the subject on the basis of the plurality of images; and
changing a set value of an imaging unit for imaging a particular part of the subject, in accordance with the movement of the subject.
